(19) United States
(12) Patent Application Publication
(10) Pub. No.: US 2019/0318297 A1
(43) Pub. Date: Oct. 17, 2019

(54) VOLUNTARY REGISTERED MULTI-STATION WATER DELIVERY SYSTEM

(71) Applicant: Kuang F. Cheng, Taipei City (TW)

(72) Inventor: Kuang F. Cheng, Taipei City (TW)

(21) Appl. No.: 15/952,260

(22) Filed: Apr. 13, 2018

(51) Int. Cl. G06Q 10/08; G06Q 50/06

(52) U.S. Cl. CPC G06Q 10/083; G06Q 50/06

(57) ABSTRACT

A voluntary registered multi-station water delivery system includes a network station which is connected to water plants. The water plants can supply water tanks to water stations. A buyer enter into the network station through his (or her) digital electronic device to provide the request for buying water. Voluntary deliverers (who are not limited to be employees of an entity having the network station) may connect to the network station 250 to request to delivery water tanks to the buyer. If the deliverer is accepted by the network station, he or she could go to a specific water stations to take water tanks and then delivery the water tanks to the buyer. The entity owning the network station need not hire any specific employee and thus the overall cost is saved and the delivery of water tanks may be made in any time.

### FIELD OF THE INVENTION

The present invention is related to water delivery system, and in particular to a voluntary registered multi-station water delivery system.

### BACKGROUND OF THE INVENTION

In many communities, people need to buy drinking water of large quantity. Currently, water plants provide services for directly supplying water to various homes, offices, or plants. However, generally, water plants are far away from the water buyers, and thus it is often that a long distance for delivery of water is needed. Furthermore the water plants need to accumulate a large amount of orders for sending water tanks to the buyers. Therefore, the overall operations are not economic.

In areas having higher density of people distribution, water stations are installed in various locations. Water plants supply water to water stations, people can go to the water stations to draw water, but people need take longer time to take water by himself or herself. Generally, water is very heavy and it is a large burden for people and thus the quantity of water to be delivered is limited. This way is only suitable to people who needs a small quantity of water.

Currently, network connection in business is popular and used in many fields which have resolved many prior problems. Therefore, the inventor of the present invention hopes to use the concept of network stations to resolve this prior art defect in delivery of water to people.

### SUMMARY OF THE INVENTION

Accordingly, the object of the present invention is to provide a voluntary registered multi-station water delivery system

To achieve above object, the present invention provides a voluntary registered multi-station water delivery system, wherein a plurality of water plants serves to make water with desired specifications and distribute the water into a plurality of water tanks; another, there are a plurality of water stations each of which stores a plurality of water tanks; when the water tanks in the water station are insufficient, the water plants will supply water tanks to the water stations; the voluntary registered multi-station water delivery system comprising:

a plurality of plant-end digital electronic devices arranged in respective water plants;

a network station for transferring messages about numbers of the water tanks in the water stations to the plant-end digital electronic devices so that the water plants can supply water tanks to the water stations if the water tanks are insufficient;

wherein the network station includes a registration unit which serves to receive requests from unspecific persons which requests to be as a water deliverer of the network station; if accepted by the network station, a person registered will become a water deliverer; the network station does not identify whether that the registering person is an employee of an entity owning the network station;

wherein the network station receives orders of water tanks from water buyers; messages about the orders are processed and then displays processed messages; the network station also receives the request for delivery of the water tanks to the buyers; requesting for delivery of the water tanks is made voluntarily; and

wherein the network station is installed in a network installation device, the network installation device is connected to all the plant-end digital electronic devices of the water plants so as to transfer the messages about water tanks to plant-end digital electronic devices of the water plants; therefore, and therefore, the water plants can supply water tanks to the water stations.

### BRIEF DESCRIPTION OF THE DRAWINGS

FIG. 1 shows the practical arrangement about the water stations and water plants of the present invention.

FIG. 2 shows another practical arrangement about the water stations and water plants of the present invention.

FIG. 3 shows an arrangement about the network station according to the present invention.

FIG. 4 shows another arrangement about the network station according to the present invention.

FIG. 5 is a schematic view showing the operation of the logic unit according to the present invention.

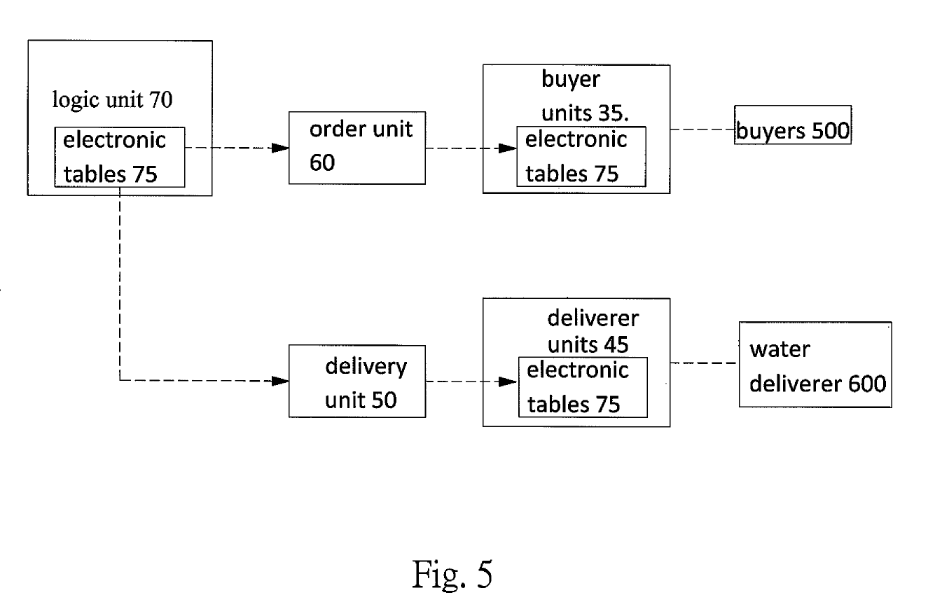

FIG. 6 is a block diagram showing the construction of the network station of the present invention.

FIG. 7 is a schematic view showing the application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

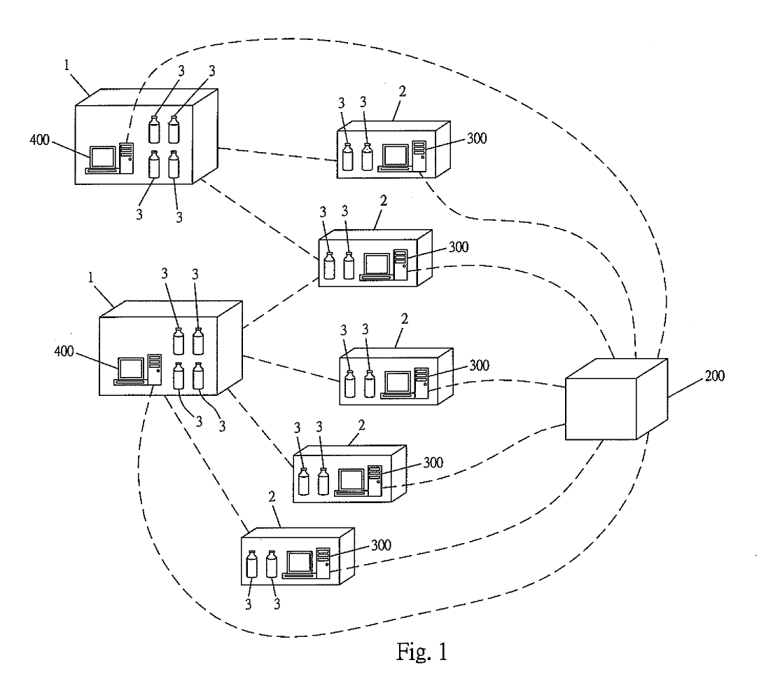

With reference to FIG. 1, the multi-station water supply system according to the present invention is illustrated. FIG. 1 shows the practical arrangement about the hardware of the present invention. In the drawing, it is illustrated in the system of the present invention, there are a plurality of water plants 1 which serve to make water with desired specifications and distribute the water into a plurality of water tanks 3. Similarly, there are a plurality of water supply stations 2 each of which stores a plurality of water tanks 3. When the amount of the water tanks 3 in the water station 2 are insufficient, the water plants 1 will supply water tanks 3 to the water station 2. In the present invention, the quantity of each water tank 3 is greater than 2 gallons.

With reference to FIG. 1, the present invention includes a plurality of plant-end digital electronic devices 400 which are arranged in respective water plants 1.

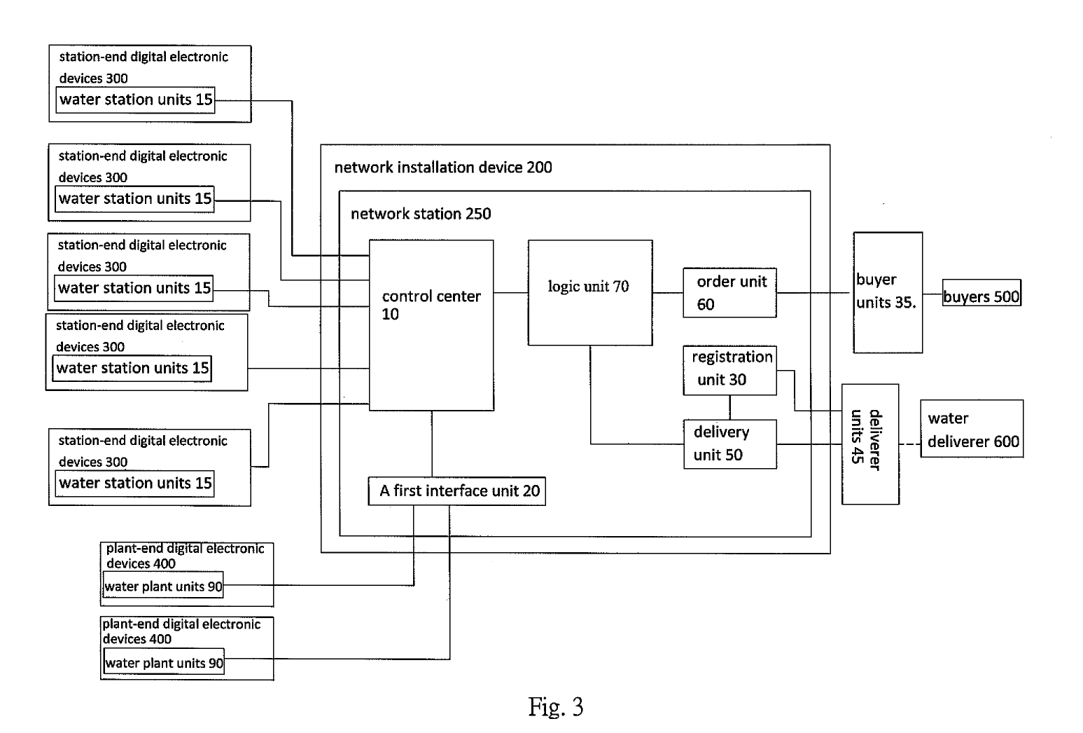

With reference to FIG. 3, it is illustrated that the present invention further includes a network station 250. The network station 250 serves to transfer information about the number of the water tanks 3 in the water stations 2 to the plant-end digital electronic devices 400 so that the water plants 1 can supply water tanks 3 to the water stations 2 as the number of water tanks 3 is insufficient.

The network station 250 includes a registration unit 30 which serves to receive requests from unspecific persons which requests to be as a water deliverer 600 of the network station 250. If the request is accepted by the network station 250, the person registered will become a water deliverer 600. However, the network station 250 does not identify whether that the registering person is an employee of an entity owning the network station 250.

The network station 250 also receives orders of water tanks 3 from water buyers 3. Messages about the orders are processed and then processed messages are displayed. The network station 250 also receives the request for delivery of the water tanks to the buyers. Requesting the delivery of the water tanks by the water distributer 600 is made voluntarily.

When water in water tanks is used up, the water tank 3 is returned to the water stations so the water tanks 3 are used repeatedly. This operation will save the amount of the tanks to be used.

As illustrated in FIG. 3, it is illustrated that the network station 250 is installed in a network installation device 200, such as a server. As shown in FIG. 1, the network installation device 200 is connected to all the plant-end digital electronic devices 400 of the water plants 1 so as to transfer the messages about water tanks 3 to plant-end digital electronic devices 400 of the water plants 1. Therefore, the water plants 1 can supply water tanks 3 to the water stations 2.

With reference to FIG. 3, the network station 250 of the present invention includes the following elements.

A control center 10 is connected to a plurality of water station units 15. The control center 10 receives messages from the water station units 15 about the number of the water tanks 3 in the water stations 2. The water station units 15 are arranged on respective water stations 2.

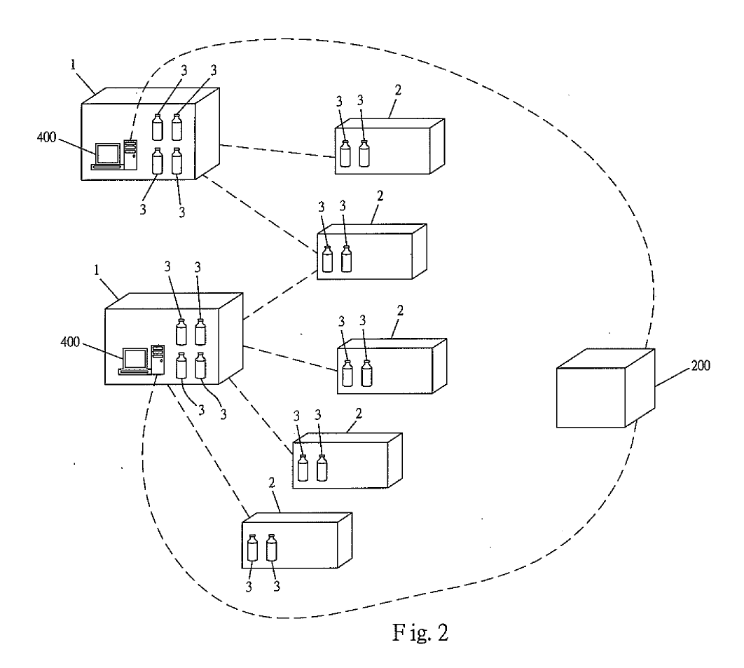

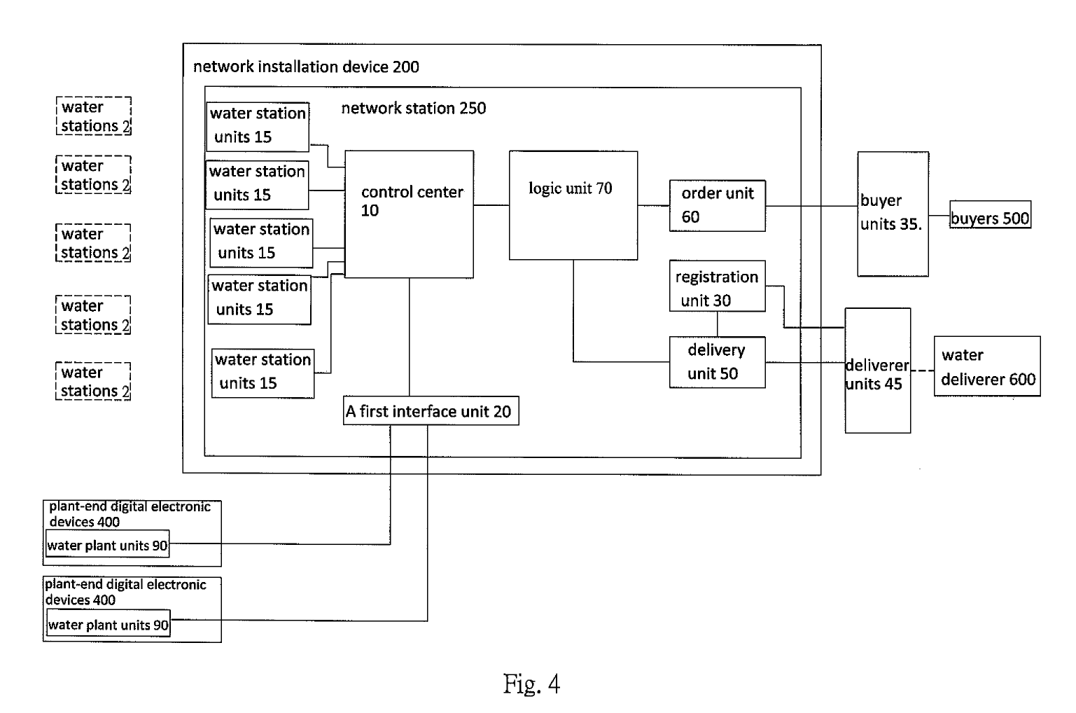

In above mentioned embodiment, the water station units 15 are arranged on the station-end digital electronic devices 300 of the water stations 2. In another embodiment, as illustrated in FIGS. 2 and 4, it is illustrated that the water station units 15 are arranged on the network stations 250. From the internal calculation of the network station 250 about the buying and delivery of the water tanks 3, each of the water station unit 15 could know the number of the water tanks 3 in the respective water station 2.

A first interface unit 20 is as an interface between the control center 10 and a plurality of water plant units 90. The control center 10 informs the message about the water tanks 3 through the water plant units 90 so that the water plant 1 can supply water tanks 3 to the water stations 2. The water plant units 90 are arranged on respective water plants 1.

In the present invention, the water plant units 90 are installed in the plant-end digital electronic devices 400.

A logic unit 70 is connected to the control center 10.

An order unit 60 is connected between the logic unit 70 and external buyer units 35. The order unit 60 causes that a buyer 500 could enter into the order unit 60 through the buyer unit 35 for making order of water. The order unit 60 receives the input messages from the buyers 500. The messages includes number of ordering water tanks 3, classifications of water, time for receiving ordered water tanks 3, addresses of the buyers, etc. The buyer unit 35 may be any of the digital electronic devices connectable to the buyer 500, such as a computer, a handset, a tablet computer, a PDA (personal digital assistance), etc.

The order unit 60 receives data input by the buyer 500, and transfers the data to the logic unit 70. The logic unit 70 provides related message according the received data from the order unit 60. The message may be number of the water tanks 3, a position of the water station 2 to provide the water tanks 3, and invoices of this order, etc. These data is formed as an electronic table 75 which is transferred to the buyer unit 35 through the order unit 60.

A delivery unit 50 is connected between the logic unit 70 and a plurality of deliverer units 45. The delivery unit 50 causes that external deliverers 600 could enter into the delivery unit 50 through the deliverer unit 45. The deliverer unit 45 may be any electronic device in the deliverer sides which could be connected to a network, such as a computer, a tablet computer, a handset, a PDA, etc.

In the present invention, the delivery unit 50 is also connected to the registration unit 30 and the registration unit 30 is connected to the deliverer unit 45 for receiving the registration requests from the deliverers 600.

The logic unit 70 displays the electronic tables 75 on the deliverer unit 45 through the delivery unit 50 so that the deliverers 600 may view the electronic tables 75.

When a deliverer 600 enters into the delivery unit 50 through the deliverer unit 45 and then is connected to the logic unit 70, the electronic tables 75 are displayed. If the deliverer 600 desires to accept the order listed on the electronic table 75, it means that the deliverer 600 agrees to go to a predetermined water station 2 to take water tanks 3 which are matched to the order listed on the electronic table 75 and then take these water tanks 3 to the buyer 500. Then, the logic unit 70 will display a message that the order is processed and a message thereabout is transferred to the control center 10 by which the message is further transferred to a respective one of the water stations 2. Therefore, the deliverer 600 may go to the predetermined water station 2 to take the ordered water tanks 3 to the buyer 500.

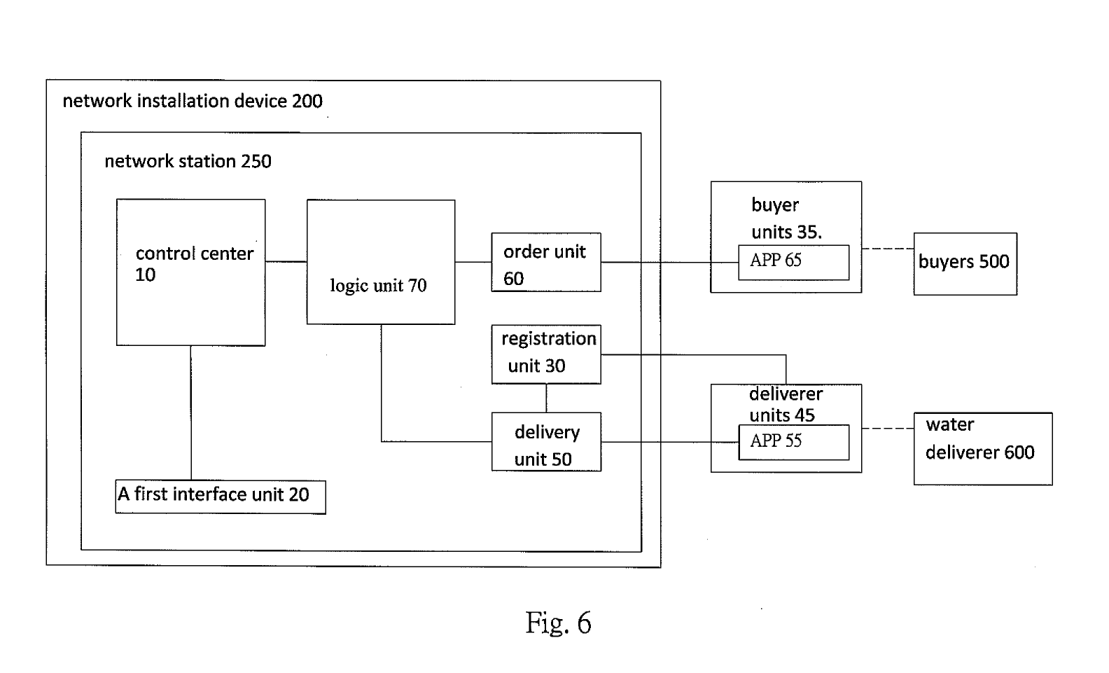

As shown in FIG. 6, the deliverer 600 may download an APP (Application program) 55 to the deliverer unit 45 from the network station 250. Thereby, the deliverer 600 may enter into the delivery unit 50 and view the electronic tables 75 from the APP 55.

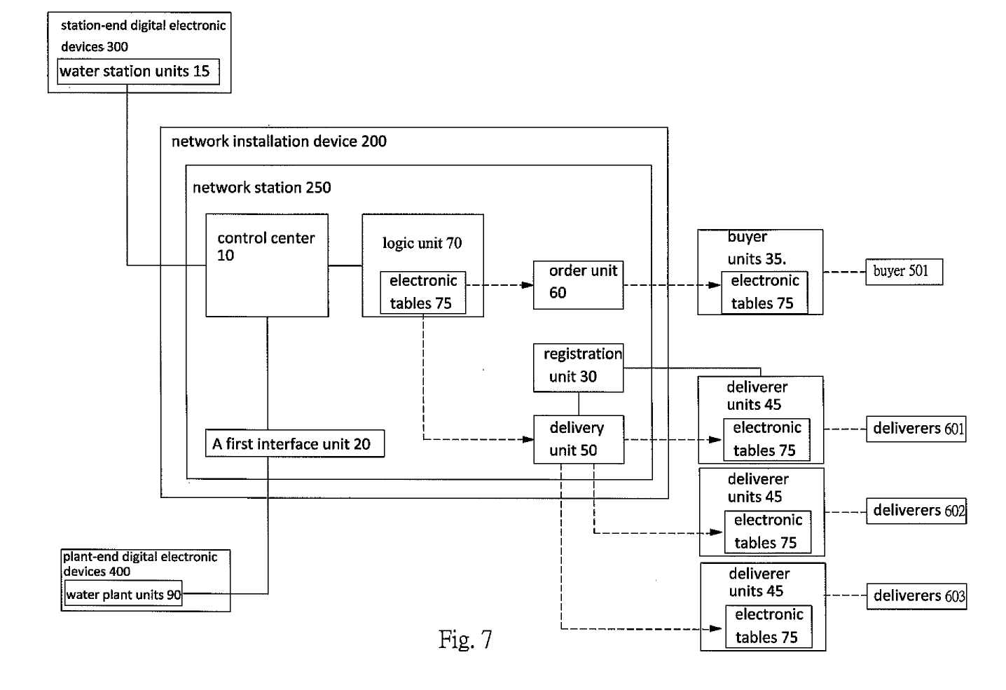

One application of the present invention will be described herein with reference to FIG. 7, in this application, a buyer 500 desires to order 5 water tanks 3. The buyer 500 could input related data from the buyer unit 35. These data are transferred to the logic unit 70. The logic unit 70 will get related messages according to the data from the buyer 500, these data may contain the number of the water tanks 3, the position of the water station 2, invoices, etc. which are formed as the electronic table 75. The electronic table 75 is transferred to the buyer unit 35 through the order unit 60.

Another, in the market there are a plurality of deliverers 601, 60, 603 which enter into the delivery unit 50 through the deliverer units 45 and thus further connect to the logic unit 70 which display the electronic table 75 to the deliverers. If one of the deliverer 601 desires to accept this order defined in the electronic table 75. Then the logic unit 70 displays a message showing that this order defined in the electronic table 75 has to be processed to the deliverer 601 and transfers this message to the control center 10 so that the control center 10 may further transfer this message to a specific water station 2 for providing the water tanks 3 to the buyer 500. Therefore, the deliverer 601 can go to the water station 2 for taking the water tanks 3 and delivery the water tanks 3 to the buyer 500. Thus the delivery of water tanks 3 to the buyer 500 is complete.

In the present invention, a network station is constructed and is connected to the water plants. Furthermore the message about the storages of the water tanks in all the water stations are transferred to the water plants so that the water plants can supply water tanks to the water stations as the water tanks in the water stations are insufficient. Furthermore, the buyer can enter into the network station through his (or her) digital electronic device to provide the request for buying water. Voluntary deliverers (who are not limited to be employees of an entity having the network station) may connect to the network station 250 to request to delivery water tanks to the buyer. If the deliverer is accepted by the network station, he or she could go to a specific water stations to take water tanks and then delivery the water tanks to the buyer. The entity owning the network station need not hire any specific employee and thus the overall cost is saved and the delivery of water tanks may be made in any time.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A voluntary registered multi-station water delivery system, wherein a plurality of water plants serves to make water with desired specifications and distribute the water into a plurality of water tanks; another, there are a plurality of water stations each of which stores a plurality of water tanks; when the water tanks in the water station are insufficient, the water plants will supply water tanks to the water stations; the voluntary registered multi-station water delivery system comprising:
a plurality of plant-end digital electronic devices arranged in respective water plants;
a network station for transferring messages about numbers of the water tanks in the water stations to the plant-end digital electronic devices so that the water plants can supply water tanks to the water stations if the water tanks are insufficient;
wherein the network station includes a registration unit which serves to receive requests from unspecific persons which requests to be as a water deliverer of the network station; if accepted by the network station, a person registered will become a water deliverer; the network station does not identify whether that the registering person is an employee of an entity owning the network station;
wherein the network station receives orders of water tanks from water buyers; messages about the orders are processed and then displays processed messages; the network station also receives the request for delivery of the water tanks to the buyers; requesting for delivery of the water tanks is made voluntarily; and
wherein the network station is installed in a network installation device, the network installation device is connected to all the plant-end digital electronic devices of the water plants so as to transfer the messages about water tanks to plant-end digital electronic devices of the water plants; therefore, and therefore, the water plants can supply water tanks to the water stations.

2. The voluntary registered multi-station water delivery system as claimed in claim 1, wherein the network station further including:
a control center connected to a plurality of water station units; the control center receiving messages from the water station units about the number of the water tanks in the water stations; and
a first interface unit being as an interface between the control center and a plurality of water plant units; the control center informing the message about numbers of water tanks through the water plant units so that the water plant can supply water tanks to the water stations; the water plant units being arranged on respective water plants.

3. The voluntary registered multi-station water delivery system as claimed in claim 2, wherein the network station further comprising:
a logic unit connected to the control center;
an order unit connected between the logic unit and buyer units; the order unit causing that a buyer could enter into the order unit through the buyer unit for making order of water; the order unit receiving the input messages from the buyers;
wherein the order unit receives data inputted by the buyer, and transfers the data to the logic unit; the logic unit provides related message according the received data from the order unit; these data is formed as an electronic table by the logic unit and then is transferred to the buyer unit through the order unit;
a delivery unit connected between the logic unit and a plurality of deliverer units; the delivery unit causing that external deliverers could enter into the delivery unit through the deliverer unit;
wherein the delivery unit is also connected to the registration unit and the registration unit is connected to the deliverer unit for receiving the registration request from the deliverers;
wherein the logic unit displays the electronic tables on the deliverer unit through the delivery unit so that the deliverers can view the electronic tables;
wherein when a deliverer enters into the delivery unit through the deliverer unit and then is connected to the logic unit, the electronic tables are displayed to the deliverer unit by the logic unit; if the deliverer desires to accept the order listed on the electronic table; it means that the deliverer agrees to a predetermined water station to take water tanks which are matched to the order listed on the electronic table and then take these water tanks to the buyer; then, the logic unit will display a message that the order is processed and a message thereabout is transferred to the control center by which the message is further transferred to a respective one of the water stations; therefore, the deliverer can go to the predetermined water station to take the ordered water tanks to the buyer.

4. The voluntary registered multi-station water delivery system as claimed in claim 2, wherein each of the water plant units is installed in a respective plant-end digital electronic device in a specific water plant.

5. The voluntary registered multi-station water delivery system as claimed in claim 3, wherein the buyer unit and the deliverer unit are digital electronic devices.

6. The voluntary registered multi-station water delivery system as claimed in claim 5, wherein the digital electronic devices are selected from computers, notebook computers, tablet computers, personal digital assistances, and handsets.

7. The voluntary registered multi-station water delivery system as claimed in claim 3, wherein messages about the orders includes number of ordering water tanks, classifications of water, time for receiving ordered water tanks, address of the buyers.

8. The voluntary registered multi-station water delivery system as claimed in claim 3, wherein the electronic table contains messages about a number of the water tanks, a position of the water station, and invoices.

9. The voluntary registered multi-station water delivery system as claimed in claim 2, wherein the plurality of station-end digital electronic devices are arranged in respective water stations; and the water station units are arranged in the respective station-end digital electronic devices.

10. The voluntary registered multi-station water delivery system as claimed in claim 2, wherein the plurality of station-end digital electronic devices are arranged in the network station; and the water station units are arranged in the respective station-end digital electronic devices; the numbers of the water tanks in the water stations are derived from the orders.

11. The voluntary registered multi-station water delivery system as claimed in claim 1, wherein a volume of each water tank is greater than 2 gallons.

12. The voluntary registered multi-station water delivery system as claimed in claim 1, wherein when water in water tanks is used up, the water tank is returned to the water stations so the water tanks are used repeatedly.
